(19) United States
(12) Patent Application Publication
(10) Pub. No.: US 2009/0052511 A1
(43) Pub. Date: Feb. 26, 2009

(54) METHOD FOR SIGNAL JITTER DETECTIONS BASED ON TIME-FREQUENCY DOMAIN ANALYSIS

(76) Inventor: WEI WU, Rolla, MO (US)

Correspondence Address: WEI WU, 3-301 SOUTH ASIA GARDEN, JIANG ROAD, WENZHOU, ZHEJIANG, 325000, CN

(21) Appl. No.: 12/036,190

(22) Filed: Feb. 22, 2008

(30) Foreign Application Priority Data
Feb. 27, 2007 (CN) 2007 100859392

(51) Int. Cl. H04B 17/00

(52) U.S. Cl. 375/226

(57) ABSTRACT

A jitter measuring method that helps the electronic system designer to reduce system jitter by tracing the jitter frequency variation and by detecting the transient jitter. The method includes below procedure: first, calculate the jitter of the signal to obtain signal jitter time trend waveform; then, decompose the jitter time trend waveform in the time-frequency domain to obtain the time varying frequency; after that, observe the decomposed results in time-frequency domain to trace out jitter frequency variation in time or to trace out transient jitter frequency and moment.

### CROSS-REFERENCE TO RELATED APPLICATION

This application claims priority under 35 U.S.C. § 119 to China Patent Application No. 2007100859392, filed on Feb. 27, 2007, in the China Intellectual Property Office, the entire contents of which are hereby incorporated by reference.

### FIELD OF THE INVENTION

The present invention relates to a signal Jitter detection method.

### BACKGROUND OF THE INVENTION

Jitter is defined by: The deviation of the significant instances of a signal from their ideal location in time. Jitter can be caused by electronic device electronic noise, thermal noise, instability of the circuit, signal transition loss and environment interference, resulting at increasing data communication error and reducing the system stability. As signalling rates climb above 2 GHz nowadays, the timing margins associated with today's high-speed serial buses and data links reveal that a tighter control of jitter is needed throughout the system design.

The currently used jitter measurement and visualization methods include:
Jitter statistics
Jitter histogram.
Jitter vs. time (Time trend).
Jitter vs. frequency (Jitter spectrum).
Eye diagram.

Where, Jitter statistics and Histogram are mostly used for random jitter analysis; Jitter vs. time is used to reveal repeating patterns that might indicate a modulation or other periodic component; Jitter vs. frequency can distinguish periodic components of signal jitter; the eye diagram is widely used for Jitter analysis since it gives insight into the amplitude behavior of the waveform as well as the timing behavior.

Jitter is commonly catalogued as Data Jitter or Clock Jitter. The present invention provides a method to detect the variation of jitter frequency and transient jitter that are common phenomena of both data and clock jitters. Considering that the data signal is synchronized by clock and is influenced by clock jitter, only the data jitter will be analyzed as examples here thereafter, but the methodology is also valid for clock jitter.

Jitter is closely related to frequency and phase modulation:

S(t)=P(2πƒ_{d}t+φ(t)) (1)

where
P is a wave shape function, e.g., sin or square wave. Jitter is commonly measured in Period Jitter:

Pₙ^{Data}=(Tₙ^{Data}-Tₙ₋₁^{Data})/(Cₙ-Cₙ₋₁) (2)

### Where:

Pₙ^{Data} is the period of data signal synchronized by S(t). T^{Data} is the VRefMid (Voltage Reference at middle of pulse edge) crossing time in either direction Cₙ is the calculated clock cycle location of Tₙ^{Data}, and is measured in Time Interval Error:

TIEₙ^{Data}=Tₙ^{Data}-T′ₙ^{Data} (3)

### Where:

TIE^{Data} is the time interval error of the data signal synchronized by S(t). T^{Data} is the data edge, the VRefMid (Voltage Reference at middle of pulse edge) crossing time in either direction. T′^{Data} is the recovered data edge by means of a PLL(phased locked loop).

By (2) and (3), the periodical phase and frequency changes in data signal synchronized by s(t) in (1) become jitter amplitude modulations in Pₙ^{Data} and TIE^{Data}. Also according to (2) and (3), any jitter changes, including jitter frequency variations, can only come from the changes of the signal under test, thus making the jitter variation analysis on Period Jitter or TIE an effective way of unveiling jitter behaviour of original signal.

The modulation described above can be analyzed by first calculating the jitter time trend waveform of the signal jitter, then performing Fourier Transform (FT) on the time trend waveform of the jitter to obtain the spectrum of the jitter. The jitter spectrum analysis approach can effectively trace out various frequencies of signal modulation. But, such the frequency of signal modulation usually varies in real world applications, and there are multi-modulations among various modulations. It will be a great help for the electric circuit designing engineer to trace the jitter origin and to further compress or remove jitter, if the jitter frequency (the result of signal phase and frequency modulation) variation in time and the multi-modulation procedure can be traced out. Unfortunately, the prior art of jitter spectrum FT analysis, when transforming the jitter time trend waveform from time domain to frequency domain, loses all the time information, resulting at the statistics value of frequency components and failing to describe the frequency components variation in time. On the other hand, besides the signal frequency and phase modulation, it is common that the electronic equipment working on complex application environment frequently faces the transient interference that may cause transient signal frequency and phase modulation (signal transient jitter). The instability of the electronic equipment circuit can also cause the transient jitter. The prior art of FT method supposes that the signal under analysis is periodical, thus fails to detect the transient jitter of a signal.

### SUMMARY OF THE INVENTION

The present invention provides an jitter frequency variation and transient jitter analysis method, to overcome the weakness of the prior art. Unlike the prior art that calculates signal jitter in the time domain or calculates signal jitter spectrum in the frequency domain, the presented invention method analyzes the signal jitter at the time-frequency domain to detect the signal jitter frequency variation and catch transient jitter. An example for time-frequency analysis is illustrated at the middle frame of FIG. 2 where the Y axis indicates the frequency distribution in spectrum while the X axis indicates the different moments in time so that the frequency variation in time can be observed obviously. The presented invention method includes below procedure: first, calculate the jitter of the signal to obtain signal jitter time trend waveform; then, decompose the jitter time trend waveform into the time-frequency domain; after that, observe the decomposed results in the time-frequency domain to trace out jitter frequency variation in time or to trace out transient jitter frequency and moment. In sum, compared with the prior art of jitter spectrum FT analysis method that calculates the frequencies of signal modulation, the presented invention method not only traces the frequency of signal modulation, but also illustrates the variation of the frequency of signal modulation in time.

The above-mentioned invention can be implemented as below.
(1) Calculate the jitter time trend waveform of the signal. The signal can be the clock signal or the data signal and is calculated according to various algorithms that evaluate the time trend of signal jitter, such as Period Jitter (PJ); Duty Cycle Jitter (DCJ); Cycle to Cycle Jitter (CCJ), and Time Interval Error (TIE).
(2) Decompose the signal jitter time trend waveform into the time-frequency domain by means of Wavelet Transform (WT), Short-Term Fourier Transform (STFT) or other time-frequency analysis algorithms. The decomposed result is illustrated in the format of image or in the format of curve.
(3) Observe the time-frequency domain image or curve of decomposed signal jitter, trace out the jitter frequency variation in time, or trace out the frequency and moment of the transient jitter.

Compared with prior art, the present invention method has prominent advantages. By means of time-frequency domain analysis of the signal jitter time trend, the invention method indicates the jitter frequency variation in time and detects the transient jitter frequency and moment that may be helpful for circuit design engineer to trace the origin of the jitter and to analyze multi-effects among various frequencies components, and to diagnose the interference source and to protect the interference. Such the jitter frequency variation measurement and transient jitter frequency and moment detection are unrealizable by the prior art.

### BRIEF DESCRIPTION OF THE DRAWING

FIG. 1 is a flow chart of the present invention method.

FIG. 2 is the signal Period Jitter (PJ) waveform and present invention method application results, consisting top, middle and bottom frames. The top frame illustrates PJ, middle frame shows the time-frequency domain image of WT analysis result of signal PJ illustrated in top frame; and the bottom frame displays the time variation of the PJ frequency relating to one frequency at 0.8 MHz indicated in the middle frame with an arrowhead.

FIG. 3 is the signal Time Interval Error (TIE) waveform and present invention method application results, consisting top, middle and bottom frames. The top frame illustrates TIE, middle frame shows the time-frequency domain image of STFT analysis result of signal TIE illustrated in top figure and in this example, only one frequency at 3.98 MHz is focused in Y axis; and the bottom frame displays the time variation of the TIE frequency relating to the frequency at 3.98 MHz indicated in the middle frame.

### DETAILED DESCRIPTION OF BEST MODE EMBODIMENTS

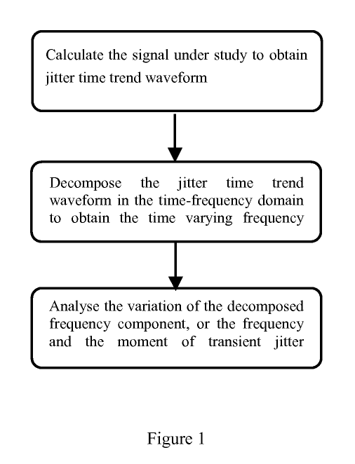

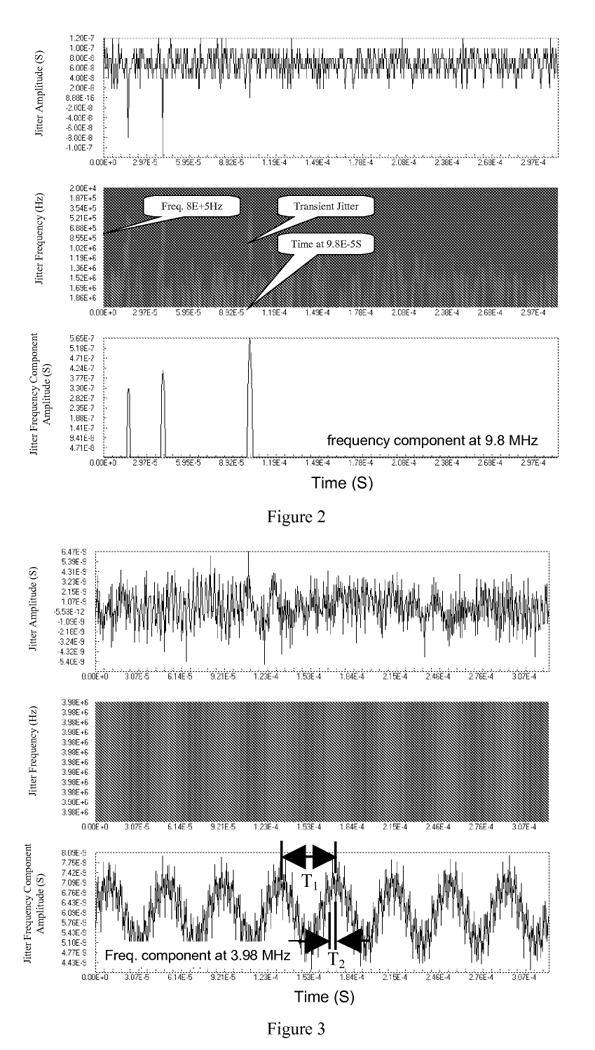

Best mode embodiment 1: This embodiment extracts the transient jitter in time-frequency domain The experimental signal is the serial pulse data acquired from an AFS 1016 Fast Ethernet Switch by an oscilloscope. FIG. 1 shows the flow chart of the process of the invention method comprising:
(1) Calculate the signal to obtain jitter time trend waveform. Various jitter calculation algorithms that illustrate the result in the format of time trend can be used. In this Best Mode Embodiment, the signal from the Switch is acquired by a digital oscilloscope and PJ of acquired signal is calculated according to (2), resulting at waveform illustrated at FIG. 2 top frame. It is well-know to the designer with ordinary skill in the pertinent art, there are many oscilloscope products integrated the jitter analysis function and can be used to acquire data from the signal and calculate the jitter time trend waveform.
(2) Decompose the PJ time trend waveform into time-frequency domain. Signal transforming from the time domain into the time-frequency domain can be achieved by means of Wavelet Transform (WT):

$$Wf ( u , s ) = {\int }_{- ∞}^{= ∞} f ( t ) \frac{1}{\sqrt{s}} ψ * ( \frac{t - u}{s} ) d t \qquad ( 4 )$$

where
Wf (u, s) is the wavelet transform coefficient after transforming;
f(t) is the time domain signal being transformed;
u is the shifting factor;
s is the scale factor;
* is the conjugate operation;

$$ψ ( \frac{t - u}{s} )$$

is the wavelet basis function that depends on u and s. A commonly used wavelet basis function is the Morlet function:

$$ψ ( \frac{t - u}{s} ) = {e}^{- {( \frac{t - u}{s} )}^{2} / 2} {e}^{j {ω}_{0} ( \frac{t - u}{u} )} \qquad ( 5 )$$

The Morlet wavelet basis function (5) acts like a filter in (4). Only the frequency components similar to Morlet basis can get high transform coefficient. One can extract different frequency components from the signal f(t) with compressed or expanded Morlet basis by changing scale parameter s , and perform the above frequency extracting process along the time axis by changing the translation parameter u. In this way, the Morlet wavelet transform extracts the frequency components of the signal f(t) throughout time axis. This is exactly what is needed to measure the frequency changes as the function of time. Another advantage of Morlet wavelet transform is that various scale parameters s and the time translation u can be used to look for a specific jitter feature of the signal under analysis. All the designers with ordinary skill in the pertinent art also know that there are many standard software such as MATLAB, can be used to calculate WT. In this embodiment, to decompose PJ time trend waveform into time-frequency domain WT in equation (4) with Morlet wavelet basis function in equation (5) is used. (3) WT transform result is shown in the format of image in the middle frame of FIG. 2, where the X axis indicates the time, Y axis indicates the frequency and the brightness of the image presents the absolute value of WT transform coefficients that present the amplitude of various frequency components. In this Best Mode Embodiment the Y axis covers the frequency span from 0.02 MHz to 2 MHz, to catch the possible transient jitter. The variations of the frequency components falling into the frequency span from 0.02 MHz to 2 MHz can be observed through the middle frame of the FIG. 2. For example, from the moment 1.2×10⁻⁴ to the moment 3×10⁻⁴ it is hard to observe the frequency components below 1 MHz in the middle frame. But at the moment about 9.8×10⁻⁵, the frequency components exist among from 0.35 MHz to 2 MHz, with energy focus at 0.8 MHz. The bottom frame of the FIG. 2 describes the amplitude variation of frequency component of 0.8 MHz. From the middle and bottom frames in FIG. 2, it is obvious that there is an isolated jitter at the moment about 9.8×10⁻⁵ among the frequency 0.35 MHz to 2 MHz that is a transient jitter.

Best mode embodiment 2: This embodiment extracts the jitter frequency time trend variation of the signal. Again, following the procedure illustrated in FIG. 1:

(1) Calculate the signal under study into the jitter time trend waveform. The experimental signal is the serial pulse data that is acquired from an AFS 1016 Fast Ethernet Switch, recorded and calculated the Time Interval Error (TIE) according to (3) by an oscilloscope, resulting at the signal TIE trend waveform illustrated in the top frame of FIG. 3.

(2) The signal TIE time trend waveform is decomposed into the time-frequency domain. In this embodiment 2, the Short-Term Fourier Transform (STFT) is used:

Sƒ(u,Ω))=∫_{-∞}^{+∞}ƒ(t)g(t−u)e^{-tax}dt (6)

where
g(t−u) is the window function;
U is the shifting factor;
ƒ(t) is the time domain signal being transformed; and
Sƒ(u,Ω)) is the STFT coefficient after transforming.

It is well-know for the designer with ordinary skill in the pertinent art that STFT transforms the signal from time domain to time-frequency domain and is totally different than the Fast Fourier Transform (FFT) that transforms the signal from time domain into frequency domain. Although both WT and STFT can transform signal from time domain to time-frequency domain, generally speaking, WT has better time-frequency-window property than STFT.

(3) The STFT transforming result, the STFT coefficients, are presented in the middle frame of FIG. 3 where the X axis indicates the time, Y axis indicates the frequency and the brightness of the image presents the absolute value of STFT transform coefficients that present the amplitude of various frequency components (in this embodiment, only one frequency component at 3.98 MHz is illustrated). The bottom frame describes that the 3.98 MHz frequency component illustrated in the middle frame, is modulated thus oscillated in period T₁ and in period T₂.

As described above, the principle and function of presented invention method are: by analyzing the signal jitter time trend waveform in the time-frequency domain, extract the jitter frequency components variation and detect the transient jitter. Above Best mode embodiments are used to illustrate, but not to limit the principle and the function of the presented invention method. For example, the time-frequency domain analysis result described in above embodiments can also be analyzed directly by computer to give the same conclusion, without displaying the image or curve in screen; different type of Wavelet basis function instead of Morlet basis function can be used; the transform to time-frequency domain is achieved by means of other transform algorithms. Any modification according to the principle and function of this invention described above by the designer with ordinary skill in the pertinent art will not change the coverage of this invention.

1. An jitter measuring method comprising:
Calculating the jitter of signal under study and obtain jitter time trend waveform; and decomposing the jitter time trend waveform into time-frequency domain; find out the jitter characters from decomposing results.

2. The method according to claim 1, further comprising:
The signal under study includes clock signal or data signal.

3. The method of claim 1, wherein the method for decomposing the jitter time trend waveform into time-frequency domain includes wavelet transform or short-term Fourier transform.

4. The method of claim 1, wherein finding out the jitter characters from decomposing results, includes finding out the frequency components variation of jitter, or finding out transient jitter.
